(19) United States
(12) Patent Application Publication
(10) Pub. No.: US 2026/0363833 A1
(43) Pub. Date: Nov. 19, 2026

(54) SNAP ON CORRECTOR FOR ORTHODONTIC TREATMENT

(71) Applicant: Mohammad IZADI, Timonium, MD (US)

(72) Inventor: Mohammad IZADI, Timonium, MD (US)

(21) Appl. No.: 19/465,631

(22) Filed: Jan. 30, 2026

Related U.S. Application Data
(63) Continuation of application No. PCT/US2024/046472, filed on Sep. 12, 2024.
(60) Provisional application No. 63/599,047, filed on Nov. 15, 2023.

(30) Foreign Application Priority Data
Nov. 15, 2023 (US) 63599047
Apr. 26, 2024 (US) 63639458

(51) Int. Cl. A61C 7/36

(52) U.S. Cl. CPC A61C 7/36

(57) ABSTRACT

A snap on corrector for orthodontic treatment. The originally designed corrector having a variable tension pull rod having a two-piece construction including: an elongated spring having a threaded portion at one end; and a threaded rod with a correspondingly threaded portion to fit into the threaded portion of the elongated spring; a first socket connector connected to an end of the elongated spring; and a second socket connector connected to an end of the threaded rod, the second socket connector at an end distal from the first socket connector during insertion of the threaded rod in the elongated spring. In an embodiment, the corrector includes a spring in connection with a telescopic push rod mechanism for maintaining active pressure for corrections. In an embodiment, the corrector includes snap-on buttons for connection in both areas with aligners or modified braces.

### CROSS-REFERENCE TO RELATED APPLICATIONS

This present application is a Continuation of International Application No. PCT/US2024/046472 filed on Sep. 12, 2024, which claims benefit of priority to U.S. Provisional Application No. 63/599,047 filed Nov. 15, 2023 and U.S. Provisional Application No. 63/639,458 filed Apr. 26, 2024, the entire contents of which are incorporated herein by reference.

### BACKGROUND

### Correctors

In Orthodontics, correction of malocclusions (bad/incorrect bites) are very challenging at times. Often, there are skeletal and dental issues which must be corrected accordingly. Looking at the patient's profile, in Class I skeletal and dental situations, the upper and lower jaws align relatively well compared to each other, and the posterior teeth in the back fit into each other correctly; however, the front teeth may or may not fit together. There are also Class II and Class III skeletal and dental malocclusions. In Class II skeletal issues by looking at the patient's profile, the lower jaw is too far back or the upper jaw could be too far forward (or both) in relation to each other and or in relation to what is called the Cranial base. In general, in Class II dental malocclusions by looking at the patient's profile, the lower teeth are too far back or the upper teeth appear too far forward (bucked teeth) and do not fit into each other correctly. Class III is the exact opposite of Class II, where the lower jaw/teeth appear too far forward and the patient may even have an anterior crossbite (underbite). Most common drastic movements of the upper and lower teeth are performed with the help of rubber bands (elastics) in order to achieve corrections. These corrections are not that easy at times even with braces and are even more challenging with aligner treatments. Rubber bands are effective only on a limited basis and also require a patient's compliance with either braces or the aligners. In growing children, growth modifications will be attempted via extraoral or other intraoral devices. In adults with significant skeletal Class II and III discrepancies, orthognathic surgery must be considered or if the patient does not want to go through surgery, camouflaging may be considered with extractions of teeth with again significant dental movements.

### Attachment Placements

Attachments are made out of dental composites that are placed on teeth to help facilitate certain difficult movements, and allow the aligners to seat better and grab on teeth to remain active. Placement of attachments currently requires an attachment template. These attachment templates have the exact negative shapes of the attachments (dimples) built in them. After preparation of teeth requiring the attachments with cleaning, one-minute acid etching, rinsing and drying the teeth, a coat of primer is applied on teeth. The attachment template with the built-in negatives of the attachments are filled with the composite material, and seated over all the teeth. A curing light is shined for 3 to 6 seconds directly on each attachment, and the attachments are hardened, placed, and bonded on the teeth. The template is removed and the attachments are now ready for clean up by the doctor.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-17 are diagrams of one or more embodiments usable in connection with one or more embodiments of the disclosed invention.

FIGS. 18-28 are images of one or more embodiments usable in connection with one or more embodiments of the disclosed invention.

FIG. 29 is a high-level block diagram of a processing system usable in conjunction with one or more embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

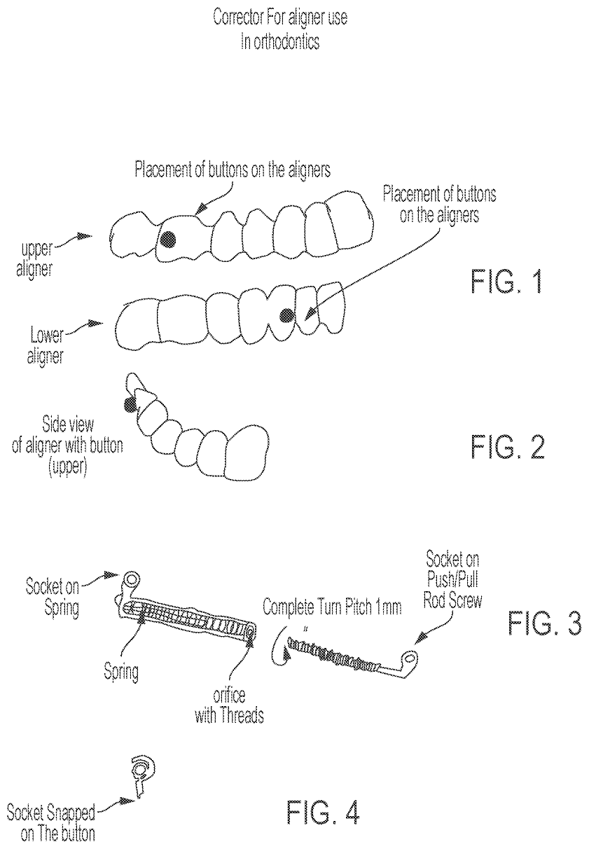

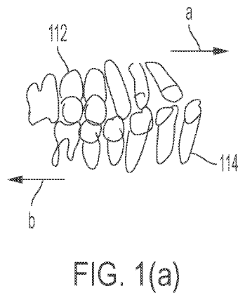

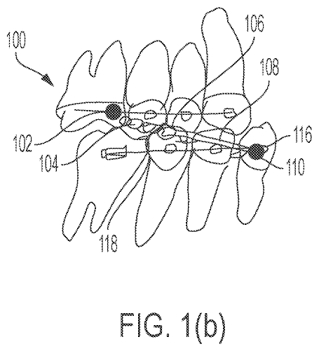

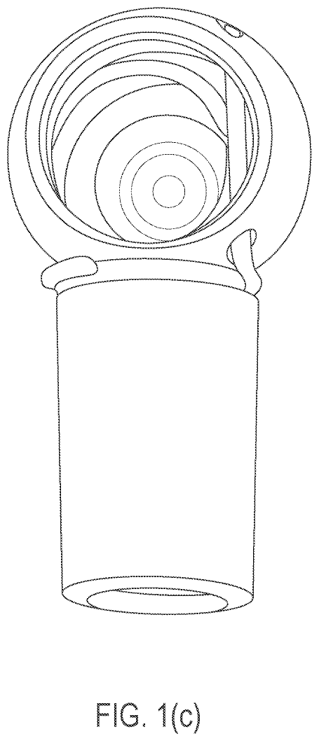

FIG. 1(a) and 1(b) are corresponding views of an upper and lower set of teeth and an orthodontic device 100 correcting an upper jaw and/or teeth 112 and a lower jaw and/or teeth 114 having Class III skeletal and dental issues that need to be corrected, according to at least one embodiment of the present invention. Turning to FIG. 1(b), orthodontic device 100 includes a first socket connector 102, a spring 104, a threaded portion 106, a push/pull rod 108, and a second socket connector 110. First socket connector 102 is connected at one end of spring 104 and releasably connectable with a ball or other connection mechanism on a tooth. Spring 104 is connected with threaded portion 106 at another end distal from first socket connector 102. Push/pull rod 108 is threaded at one end and inserted into spring 104 and releasably connectable via second socket connector 110 at the other end distal from spring 104 with a ball or other connection mechanism on a tooth. In some embodiments, spring 104 is referred to as a tension spring or a compression spring depending on the direction of the force being applied.

First socket connector 102 is a socket connector having a concave opening for releasably receiving a ball or other connection mechanism inside. In at least some embodiments, the socket connector opening is smaller than the diameter of the ball. In at least some embodiments, the socket connector is ring-shaped and sized to releasably connect with a ball or other connection mechanism. In at least some embodiments, the socket connector is a Bansbach style connector as shown in FIG. 1(c). The Bansbach style socket connector has a flexible spring inside the socket to allow for the ball to be pushed into the interior and secured tightly inside with ease, and to allow for easier snapping off the socket away from the ball by a 90 degree pulling away action.

In at least some embodiments, the ball is referred to as a button. In at least some embodiments, the ball is at least partially raised away from a surface to which it is mounted. In at least some embodiments, the ball is button-shaped and has a rounded outer periphery. In at least some embodiments, the ball is less than a complete sphere. In at least some embodiments, the ball is a rounded rectangle or other polyhedral shape in plan view.

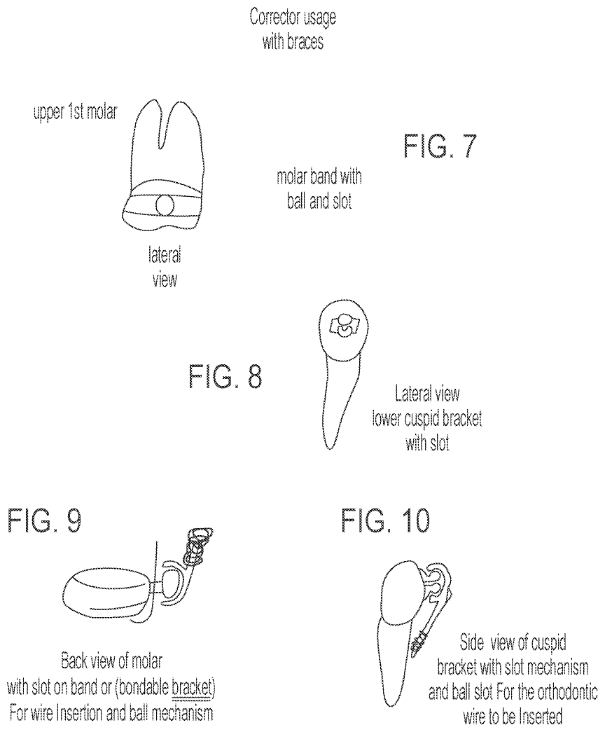

FIG. 7 is a view of a molar band having a ball attached to the band. The ball is for connecting with the socket connector 102/110 of the device 100. FIG. 8 is a lateral view of a lower cuspid bracket mounted on a tooth. The lower cuspid bracket has a portion to which socket connector 102/110 is able to connect. The bracket has a slot through the center allowing for orthodontic wire to be passed through. FIG. 9 is a top cross section view of the FIG. 7 molar band having a ball mounted thereon. The ball mount includes a slot for orthodontic wire insertion. Socket connector 102/110 is shown connected to the ball on the band. FIG. 10 is a cross section view of the bracket mount of FIG. 8. Socket connector 102/110 is shown connected to the bracket mount and the slot through the bracket mount for receiving the orthodontic wire is visible.

In at least some embodiments, the ball diameter ranges from 1-3 mm. In at least some embodiments, the ball diameter ranges from 1.25 mm to 2.5 mm. Correspondingly, the diameter of the opening of socket connector 102/110 ranges from 0-0.3 mm smaller than the ball diameter. In at least one embodiment, the socket connector opening is 0.2 mm smaller in diameter than the ball diameter.

In at least some embodiments, the ball and socket connector are complementary shapes to enable them to fit together. In at least some embodiments, the socket connector is flexible in at least the opening edge such that the ball to be received inside is able to slide into the opening. In at least some embodiments, the ball is flexible in diameter sufficient to fit through the opening edge of the socket connector. In at least some embodiments, the socket connector is sufficiently snug that the connector snaps onto the ball and is retained in position by the friction fit of the connector with the ball. In at least some embodiments, the socket includes a spring or other retaining mechanism in the interior thereof to retain the ball therein.

Second socket connector 110 is connected at an end of push/pull rod 108 distal from spring 104 and the threaded end of the pull rod. In at least some embodiments, second socket connector 110 and push/pull rod 108 are integrated and formed as a single unit. In at least some embodiments, second socket connector 110 is attachable to the end of push/pull rod 108.

In at least some embodiments, second socket connector 110 is the same as first socket connector 102. In at least some embodiments, second socket connector 110 is larger or smaller than first socket connector 102. In at least some embodiments, second socket connector 110 opening is larger or smaller than first socket connector opening 102. In at least one embodiment, first and second socket connector and the corresponding openings are the same size.

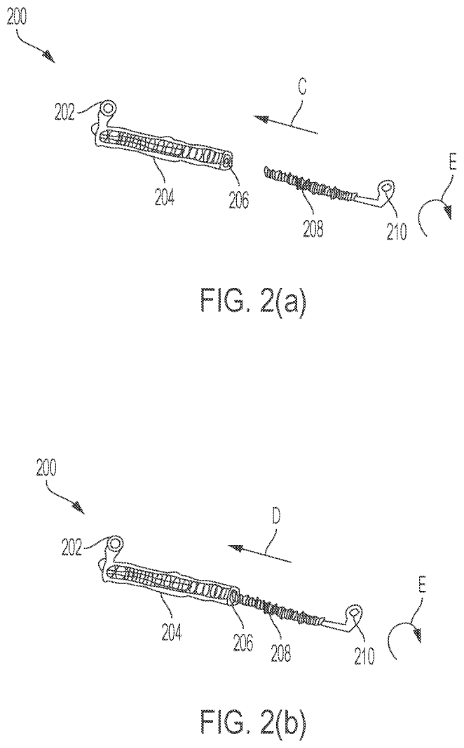

In at least some embodiments, orthodontic device 100 is usable with braces and/or combined with other fixed appliances or aligners connected/connectable to upper jaw and/or teeth 112 and lower jaw and/or teeth 114 in early treatment of growing children or of adults. FIG. 1(a) shows an example of lower jaw and/or teeth 114, sitting more forward compared to upper jaw and/or teeth 112, which can be corrected by orthodontic device 100. Arrows a and b in FIG. 1(a) show directions of movement needed for upper jaw and/or teeth 112 and lower jaw and/or teeth 114, respectively, in order to correct the Class III skeletal and dental issues, according to at least one embodiment of the present invention. FIG. 1(b) shows an example of orthodontic device 100 in use for correcting the Class III skeletal and dental issues of FIG. 1(a), according to at least one embodiment of the present invention. In at least some embodiments, first socket connector 102 of orthodontic device 100 is mounted on an orthodontic mount (also referred to as a band) on an upper molar or upper teeth 112 of a patient. In at least some embodiments, second socket connector 110 of orthodontic device 100 is connected with an orthodontic bracket on a bicuspid mount 116 on lower teeth 114. In at least some embodiments, the bracket on mount 116 includes a split bracket enabling the use of orthodontic wire 118 at the same time. In at least some embodiments, the correction of skeletal and dental issues can be performed by an orthodontic device 200 shown in FIG. 2(a) and 2(b), which will be explained hereinafter. In an embodiment for Class II issues, spring 104 is a compression spring. In an embodiment for Class III issues, spring 104 is a tension spring.

FIG. 2(a) and 2(b) are views of an orthodontic device 200, according to at least one embodiment of the present invention. In at least some embodiments, orthodontic device 200 is similar to orthodontic device 100 shown in FIG. 1(b). Orthodontic device 200 includes a first socket connector 202 (similar to first socket connector 102), a spring 204, a threaded portion 206, a push/pull rod 208, and a second socket connector 210 (similar to second socket connector 110). In at least some embodiments, spring 204 is connected to first socket connector 202 at one end and is connected to second socket connector 210 of push/pull rod 208 through threaded portion 206 at an opposite end. In at least some embodiments, spring 204 and push/pull rod 208 are assembled to be a variable tension push/pull rod. In at least some embodiments, the variable tension push/pull rod has a two-piece construction. FIG. 2(a) is a view of orthodontic device 200 before connecting push/pull rod 208 to spring 204, according to at least one embodiment of the present invention. FIG. 2(b) is a view of orthodontic device 200 after connecting push/pull rod 208 to spring 204, according to at least one embodiment of the present invention.

First socket connector 202 is configured to connect spring 204 to an orthodontic mount (also referred to as a band) on an upper molar of a patient. In at least some embodiments, first socket connector 202 is a socket connector as described above. In at least some embodiments, first socket connector 202 is connected to an end of an elongated spring. In at least some embodiments, first socket connector 202 is configured to snap onto a ball on the orthodontic mount. In some embodiments, first socket connector 202 is configured to snap onto a button on the orthodontic mount. In at least some embodiments, due to a bias of tension by pressing the first socket connector 202 onto the ball, the first socket connector 202 is securely retained from slipping off the ball.

In at least some embodiments, first socket connector 202 snap locks gently onto the button. In at least some embodiments, first socket connector 202 need not lock very tightly because the patient or a parent should be able to remove the connector and there is a natural pull force in a direction transverse the installation/removal direction on the connector once in position, so the connector will stay in place.

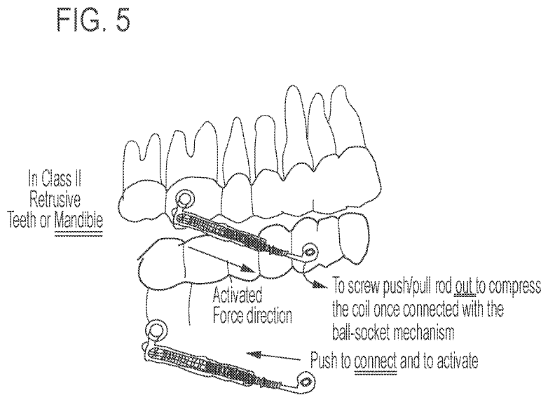

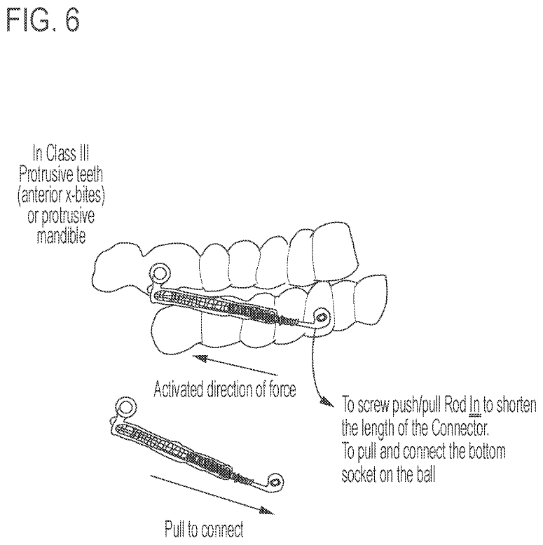

Spring 204 is configured to connect first socket connector 202 and second socket connector 210 at two opposite ends of spring 204, respectively. In at least some embodiments, spring 204 is an elongated spring with a threaded portion at one end. In at least one embodiment, spring 204 includes a portion at one end configured to engage with a threaded portion being inserted therein, e.g., a threaded portion of push/pull rod 208 described below. In at least some embodiments, depending on the application, spring 204 may have various sizes. In at least some embodiments, in a Class III correction application (for example, as shown in FIG. 6), spring 204 is shorter in length. In at least some embodiments, in a Class II correction application (for example, as shown in FIG. 5), spring 204 is longer in length. In other embodiments, spring 204 has a larger or smaller amount of elastic force to assist with pushing or pulling tension.

In at least some embodiments, a size of compression spring 204 is generally about 23 mm, for Class II (Forsus™-like) correction. In at least some embodiments, after activation, compression spring 204 should not exert more than about 4-6 oz of pressure in either case. In at least some embodiments, at least one benefit of orthodontic device 200 is that the device is easily adjusted to create the forces needed by threading in and out of the push/pull rod 208. In Class III correction, there is a possibility that the span might be longer due to the longer lower jaw size. In at least some embodiments, compression spring 204 in case of Class II is kept a bit longer so it becomes active when the patient closes the mouth. The tension spring in Class III correction must be a bit shorter than the compression spring in Class II correction, in order to create a pulling action as soon as it is installed. In some embodiments, a spring that can act both as a compression (pushing away) and a tension spring (pulling together) is contemplated. In at least some embodiments, compression/tension spring 204 is in one of at least three sizes of 23 mm, 25 mm, or 27 mm, which give the operator flexibility. In at least some embodiments, longer or shorter lengths of spring 204 are usable.

Threaded portion 206 is configured to connect spring 204 with push/pull rod 208. In at least some embodiments, orthodontic device 200 is a metallic two-piece construction having elongated spring 204 with threaded portion 206 at one end, and push/pull rod 208 with a correspondingly threaded portion to fit into threaded portion 206 of spring 204. The opposite end of elongated spring 204 from the threaded portion has first socket connector 202 connected thereto. The opposite end of threaded push/pull rod 208 from the threaded portion has second socket connector 210 connected thereto. In at least some embodiments, threaded portion 206 is a screw hole, and push/pull rod 208 is screwed in the screw hole.

Push/pull rod 208 is configured to have a threaded end connected to spring 204 through threaded portion 206 and a second socket connector located at another end connected with a ball on a bicuspid mount 116 on lower teeth 114. In at least some embodiments, push/pull rod 208 is threaded on one end which is configured to be threaded into spring 204, and the other end of push/pull rod 208 has second socket connector 210. In at least some embodiments, push/pull rod 208 is a threaded rod with a correspondingly threaded portion to fit into the spring threaded portion.

Push/pull rod 208 is adjustable and is also referred to as pull/push rod 208. Pull/push rod 208 can be screwed in or out of the spring 204 for different kinds of activation, as needed. If pull/push rod 208 is turned counterclockwise, the rod unscrews and gets longer; and with a clockwise rotation, the rod gets shorter. In at least some embodiments, the threading on pull/push rod 208 is reverse. Each complete turn has a pitch ranging from 0.05 mm to 1 mm. Because this will be removable and we do not want the activation to get lost by accidentally being able to turn pull/push rod 208 easily, in an embodiment rod 208 includes measurement markings along the length. In an embodiment, the markings are laser etched along rod 208. This can be indicated in millimeters on the pull/push rods. In an embodiment, rod 208 is configured to click to stabilize with each complete turn, or has enough friction so the rod will not turn with ease. Therefore, when we activate, we can instruct the patient that the pull/push rod 208 is on a particular activation level (3 mm, 5 mm, or the like . . . ) so if they accidentally turn the rod, the patient knows at what activation level rod 208 needs to be set. This is applicable for both braces and aligner designs to keep it simple. In a Class II correction embodiment, the threaded part of the pull/push rod is the same size as within the compressed spring to prevent the spring from bulging out to the patient's cheek, when the spring is fully compressed. In a Class III correction embodiment, the rod need not be as long as in a Class II embodiment due to the pulling action in the Class III embodiment.

For the aligners or even braces, the arm and the push/pull rods are made in tooth color or clear strong and rigid acrylic (safe for dental) materials, and (in an embodiment) only keep the spring in stainless (if need be for efficacy) or even white color springs. We want them to look incognito and actually they will be, because they attach from the upper molars to the lower cuspid area, and they get covered with the cheeks very nicely. Also, they will be lighter in weight and stay mouth-friendlier.

The spring 204 size generally is about 23 mm, for Class II (Forsus-like) correction and after activation the spring 204 should not exert more than about 4-6 oz of pressure in either case, in some embodiments. At least one benefit of an embodiment of this device is that it is easily adjusted to create the forces needed by threading in and out. In Class III correction, there is a possibility that the span might be longer due to the longer lower jaw size, so keeping the spring of about the same size (in such a way that the spring 204 is made to have both pulling and pushing capabilities) is contemplated to work as well. Having fully compressed springs in five sizes of 18 mm, 22 mm, 25 mm, or 29 mm or 32 mm gives the operator flexibility. In some embodiments, longer or shorter spring 204 lengths are usable. In at least one embodiment, a total push/pull rod of about 30 mm in length with the threaded portion of about 6-8 mm again will be sufficient to create a pull (threaded in to make shorter) or push (threaded out to make longer) action. In a Forsus-style arrangement embodiment, the spring 204 size is always the same as about 23 mm, and we have different size rods to be able to activate initially. An issue that arises in other approaches is if the patient opens the mouth wide, the rod and the spring sometimes may separate due to its design and can potentially hurt the patient. In at least one embodiment of the present invention, the spring 204 can never be separated from the push/pull rod no matter how wide the patient opens, because the two pieces are screwed together.

In operation, the first socket connector is attached to a ball on an upper molar of the patient. The threaded rod 208 is threaded into the spring 204 to a first distance or depth. In at least one embodiment, the first distance is two millimeters. The second socket connector is attached to a ball on a mount on a lower tooth of the patient. The length of the variable tension push/pull rod when the spring 204 is not under tension and the threaded rod is attached is less than the distance from the upper molar attachment point to the lower mount on the teeth. In at least some embodiments, the threaded rod 208 is turned to be threaded into the spring 204 while leaving an additional four millimeters (4 mm) of threading available on the threaded rod 208. In this manner, when attaching the second socket connector to mount on the lower tooth, the spring 204 is put under tension and stays active (under tension) at all times. Thus, when the patient opens his mouth, the tension in the push/pull rod 208 results in even a more but yet gentle pulling motion (back into the patient's mouth) on the lower teeth and a pushing motion (out of the patient's mouth) on the upper teeth. In some embodiments, the additional threading is about 6 mm instead of 4 mm. A goal of the additional threading is to impart a range of tension from about 6 ounces to about 8 ounces of force. In at least one embodiment, each complete rotation of the threaded rod 208 into the spring adjusts the tension force by 2 ounces of forces due to shortening the span of the device.

As the teeth shift, the spring 204 becomes less under tension. At a later time (after sufficient movement of teeth), the second socket connector is easily disconnected from ball on the mount on the lower tooth, and the threaded rod 208 is turned in clockwise to be threaded further into the spring 204. In other embodiments, the threading in the rod 208 and spring 204 is such that the threaded rod 208 is turned counter-clockwise to be threaded further into the spring 204. The overall length of the variable tension rod 208 is thereby reduced. In some embodiments, the threaded rod 208 is turned each time to reduce the overall length by one millimeter. In some embodiments, each turn of the threaded rod 208 reduces the overall length by more or less than one millimeter. The second socket connector is then reattached to the same ball on the lower tooth mount thereby putting the spring 204 into tension and continuing to pull on the lower teeth and push on the upper teeth. The process is then repeated.

Thus, the doctor is able to vary the amount of force being applied to the movement of the teeth by greater or lesser threading of the threaded rod 208 into the spring 204. Additionally, repositioning of the attachment is simplified using the second socket connector. Current approaches using a Forsus appliance require the crimping of wire ends in the mouth of the patient which is uncomfortable, awkward, time consuming, and with the possibility of harm to the patient. Additionally, the socket connector (first or second) is easily removed from the respective ball on a tooth mount, i.e., the socket connector is popped off the ball.

In another embodiment, the device is used in a push manner to create separation. That is, the tension spring 204 part provides elastic force to push the upper first socket connector away from the lower second socket connector. In this manner, the upper teeth are pushed toward the back of the patient mouth and the lower teeth are pushed toward the front of the mouth. Adjustments to the threaded part cause the threaded part to be removed from the tension spring 204 rather than inserted deeper. In at least some embodiments, at least a portion of the push/pull rod 208 near the second socket connector is angled to minimize the rod from flipping out into the patient's cheek. In at least some embodiments, depending on the application, the tension spring 204 has a different size. For example, in a Class III correction application, the spring 204 is shorter in length. In a Class II correction application, the tension spring 204 is longer in length. In other embodiments, the tension spring 204 has a larger or smaller amount of elastic force to assist with pushing or pulling tension.

In at least some embodiments, a total length of push/pull rod 208 is about 30 mm with the threaded portion of about 6-8 mm, which will be sufficient to create a pull (threaded in to make the total length of pull rod 208 and tension spring 204 shorter) or push (threaded out to make the total length of push/pull rod 208 and tension spring 204 longer) action. In at least some embodiments, in a Forsus™-style arrangement, the size of tension spring 204 is always the same as about 23 mm, and push/pull rod 208 has different sizes to be able to activate initially. In other conventional approaches, an issue arises when the patient opens the mouth wide, the push/pull rod and the tension spring sometimes may separate due to its design and can potentially hurt the patient. In at least some embodiments of the present invention, tension spring 204 will not be separated with push/pull rod 208, no matter how wide the patient's mouth opens, because tension spring 204 and push/pull rod 208 are screwed together through threaded portion 206.

Second socket connector 210 is configured to connect push/pull rod 208 to a ball on a mount 116 on a lower tooth 114 of a patient. In at least some embodiments, second socket connector 210 is connected at one end of push/pull rod 208. In at least some embodiments, second socket connector 210 is connected to an end of a threaded rod 208. In at least some embodiments, second socket connector 210 is at one end of push/pull rod 208 opposite to the other end of the push/pull rod 208 where first socket connector 202 is located. In at least some embodiments, second socket connector 210 is hingedly or rotationally crimped at the end of push/pull rod 208. The socket connector enables quick and easy release of second locking module 210 and push/pull rod 208 from the ball. In at least some embodiments, second socket connector 210 can then be repositioned on a different mount on a different lower tooth 114 of the patient.

In at least some embodiments, orthodontic device 200 is used in a push manner to create separation. That is, in at least some embodiments, spring 204 provides elastic force to push the upper first socket connector 202 away from the lower second socket connector 210. In this manner, upper teeth 112 are pushed toward the back of the patient mouth and lower teeth 114 are pushed toward the front of the mouth. In at least some embodiments, adjustments made to threaded portion 206 cause threaded portion 206 to be removed from spring 204 rather than inserted deeper. In at least some embodiments, at least a portion of the push/pull rod 208 near second socket connector 210 is angled to minimize push/pull rod 208 from flipping out into the patient's cheek.

In FIG. 2(a) and 2(b), arrows c and d show a direction of movement needed for push/pull rod 208 to be threaded into spring 204. Arrow e shows a direction of rotation that push/pull rod 208 is turned to be threaded into the spring. In at least some embodiments, the threading in push/pull rod 208 and spring 204 is such that the threaded push/pull rod 208 is turned to be threaded further into the spring, and an overall length of push/pull rod 208 and spring 204 is thereby reduced.

Orthodontic device 200 is able to correct both Class II and Class III conditions depending on how the device is adjusted, i.e., whether to keep the spring under pulling tension by shortening the span of the device or to make the spring active (pushing) by lengthening the span of the device. In a first configuration, the spring is kept under pulling tension by screwing the pull/push rod clockwise to shorten the span of the assembly, thereby creating a pulling action to correct the Class III malocclusion when the spring is pulled to connect the socket connector on the ball mount on the band. In a second configuration, the spring is made active by rotating the pull/push rod counterclockwise to make the assembly longer and to create a pushing action by compressing the spring and snap the socket connector on the ball on a tooth mount thus to correct a Class II malocclusion (similar action to the Forsus). The socket connector snaps on the ball on the molar band for Class III and Class II corrections to prevent the hook from coming out while in use, due to the corrective forces being exerted. The same socket connector can be reversed from left side to the right and vice versa to achieve this depending on the malocclusion type that is getting corrected. For example, the right socket connector that is used for Class III can be used on the left for Class II.

### Snap on Corrector

The Snap on Corrector can be installed by the patient and removed by the patient with specific modifications made for the aligners, compared to other approaches for the usage with braces which is fixed and still can be removed by the patient but not as easily. We are generally not worried about compliance with aligners because we have to rely on patients wearing the aligners anyways, so concerns regarding compliance in placing and removing the corrector will not be a problem. The Corrector not only will be much more effective for dental corrections but also can be used with growing children for the correction of skeletal discrepancies (lack or excess growth of either jaw). The modifications needed to the corrector are as follows:
1) We will need to build ~1.25 mm to 2.5 mm diameter balls (also referred to as buttons) made preferably in acrylic or same materials as the aligners as shown on the aligners (FIG. 1). FIG. 2 is a side view of an aligner having a button attached for connection with a socket connector. FIG. 3 is another view of a socket connector as described. FIG. 4 is a side section view of a socket connector snapped on a ball or button. If the diameter of the socket of the socket connector is smaller than the ball or button diameter by about 0.2 mm, the ball or button snaps into the socket with pressure or a Bansbach spring style socket to secure the ball in the socket.
2) The buttons are placed on the upper molar (six year or twelve year molars as best fit) and lower cuspid regions of the aligners (FIG. 1). So, the placement vicinity of the corrector will be very similar to the corrector usage with the braces as described below. In an embodiment, the distance between the molar button to the cuspid button is measured with a ruler when the patient's teeth are closed together completely to see what size of a corrector is needed. In an embodiment, there are 5 different sizes of fully compressed correctors including 18 mm, 22 mm, 25 mm, 29 mm, and 32 mm in length (socket to socket) due to the different sizes of the teeth, arches and the jaws. In at least some embodiments, longer, shorter, or different length correctors are used.
3) The corrector of the same assembly as described below will be used with the following changes for usage with aligners. In at least some embodiments, the corrector is usable with braces and other orthodontics.

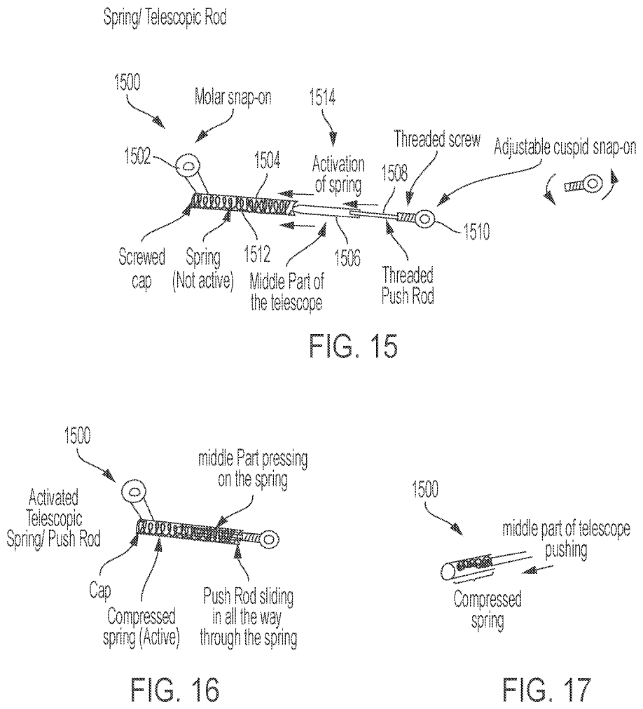

In a version according to an embodiment, a compression-activated spring-based corrector 1500 is described with reference to FIGS. 15, 16, and 17. FIG. 15 is a cross section view of corrector 1500. The corrector 1500 includes a first socket connector 1502 (as described above with respect to socket connector 102), a receiving tube segment 1504 having a hollow interior, a middle segment 1506, a threaded rod 1508, and a second socket connector 1510 (as described above with respect to socket connector 110). A spring 1512 is positioned within the hollow interior of receiving tube segment 1504. Receiving tube segment 1504, middle segment 1506, and threaded rod 1508 are collectively referred to as telescopic rod 1514. An end of receiving tube segment 1504 includes a removable cap to retain the spring within the interior. In at least one embodiment, the end of the receiving tube segment 1504 is a closed portion. In at least one embodiment, the removable cap is threaded onto the end of receiving tube segment 1504.

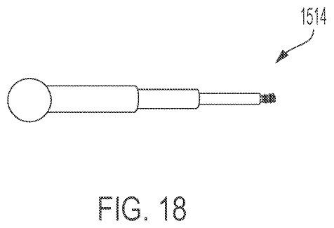

The corrector 1500 comprises the telescopic rod 1514 where the compression spring is housed within the thickest portion (also referred to as the receiving tube segment 1504) of the telescopic rod 1514. FIGS. 18-24 are images of the corrector 1500 having the compression spring housed within the telescopic rod 1514. The Corrector also comprises snap-on areas (also referred to as socket connectors 1502/1510) at opposite ends for both molar and cuspid region connections. Buttons are positioned on the aligners for both upper and lower molar areas where the snap-on areas of the connector 1500 are attachable.

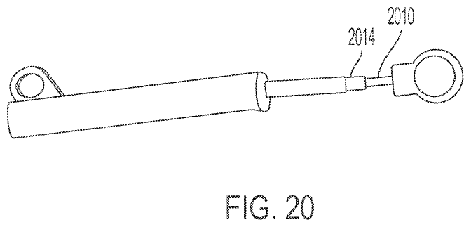

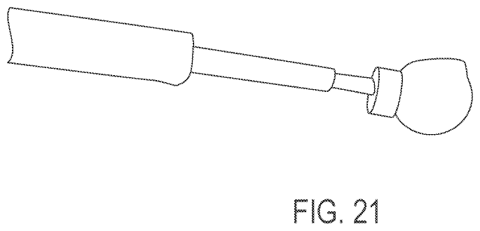

The Telescopic feature is all in one piece and does not have a threaded rod in the spring as in other approaches. The telescopic feature has an internal spring 1512 that is activated with the abutment of the end of middle segment (or cylinder) 1506 sliding upon closure of the mouth onto the spring, thus compressing the spring 1512 inside the larger cylinder of the receiving tube segment 1504 hollow interior. However, there is a threaded snap-on head part 1516 (also see 2010 (FIG. 20)) (in the cuspid area) that is threaded on the threaded rod 1508 (see also last (smallest diameter) part 2014 of FIG. 20) of the telescopic feature; which is a sliding solid rod with ~6 mm pitch at the end (FIG. 20) and the second socket connector 1510 attached thereto. Therefore, the adjustment can occur when this snap-on head gets screwed clockwise to shorten the rod span and to deactivate by eventually lessening the compression forces, or counter-clockwise turns to make it longer (as it unscrews) and make it more active by increasing the compression forces on the spring (FIG. 21).

Receiving tube segment 1504 is similar in length to spring 104/204 and again comes in five different sizes of 18 mm, 22 mm, 25 mm, 29 mm, or 32 mm. The spring within the tube segment 1504 is similar in operation to spring 104/204. The spring within the tube segment 1504 is similar in operation to compression/tension spring 104/204; however, and when fully compressed takes up no more than ~5 mm within the receiving tube. The middle part of the telescopic part 1506 that slides in and compresses the coil is about 5 mm less than the size of the receiving tube and finally the threaded push rod 1508 is the same size or even longer than the middle segment if need be to allow for maximal extension, and when compressed extends all the way through the middle of the compression spring. The threaded part of the push rod is about 6 mm in length to allow for adjustment into the socket 1510 at the end.

The corrector 1500 is adjustable during installation as well as during the process of the correction of the teeth. After the patient closes the mouth maximally, the rod 1508 slides into the middle segment 1506 to eventually push the middle segment into contact with the spring within the large cylinder, i.e., receiving tube segment 1504. FIG. 17 is a cross section view of middle segment 1506 in contact with the spring. FIG. 16 is a cross section view of middle segment in contact with the spring and threaded rod 1508 extending within middle segment 1506. The rod 1508 freely slides in the middle segment 1506 as well as within the spring in the receiving tube segment 1504. In at least some embodiments, the rod 1508 has a smaller cross section diameter than the spring. The rod 1508 is a bit longer than the middle segment 1506 to allow the telescopic feature to have the capability to become as long as possible for maximal opening of the mouth without restrictions.

FIG. 21 is an image of another version of the corrector that has a white acrylic cylinder (but could be in different colors, as well, in other embodiments) that houses the spring and the telescopic rod 1508. In at least some embodiments, the telescopic rod is metallic (FIG. 20). The plier is holding the area where the snap on head (second socket connector 1510 of the cuspid region again can be turned clockwise or counterclockwise to increase or decrease the activation of the appliance by making the corrector longer or shorter. In an embodiment, the screw portion is laser or color marked to show the patient where the head needs to be and/or make it difficult to accidentally turn. In an embodiment, each turn results in 1 mm of activation and enabling a maximum of up to 5-6 mm in activation increase or decrease. In at least some embodiments, the activation technique applies to all embodiments.

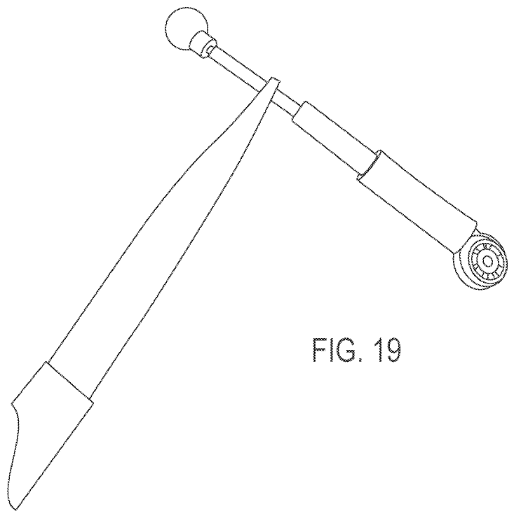

The socket connectors connect (i.e., snap) onto the buttons on the aligners to be held in place (FIG. 19). Because it is a ball-socket joint once connected, it will be very comfortable and make movement of the corrector easy in many different directions. If the socket connectors snap off a ball for any reason (usually by getting hit in the mouth), they can easily be snapped back on to the ball. In at least one embodiment, a Bansbach style socket is used for the socket connector. The Bansbach style socket has a flexible spring inside the socket to allow for the ball to be pushed into the interior and secured tightly inside with ease, and to allow for easier snapping off the socket away from the ball by a 90 degree pulling away action. The aligners and the connectors are taken out for eating and brushing or any special occasion but usually are worn at all times including bedtime. For the aligners or even braces, the arm and the push rods are manufacturable in tooth color or clear strong and rigid acrylic (safe for dental) materials. We want it to look incognito of course, and actually they will be because they attach on the sides of teeth inside the mouth and get covered with the cheeks very nicely. Also, they will be lighter in weight and stay mouth-friendlier (FIG. 19).

This appliance can be taken off during important meetings, or due to any sores in the mouth or any other important events or issues, and aligners still can be worn. If we need the patient to wear the devices only at night, they can then install the devices at night-time.

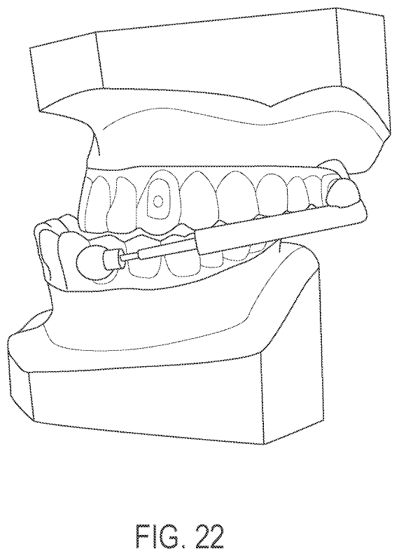

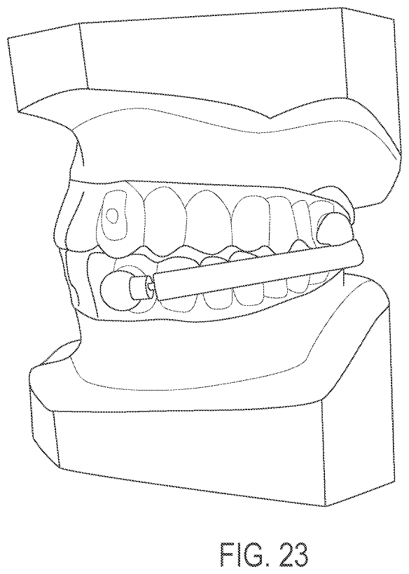

In case of patients with aligners treatment that cannot come in for their check ups on a regular basis (college students, patients that travel for living, or the like), we can evaluate the patient virtually and direct them how much to activate the Corrector if need be after certain corrections are achieved.
4) In Class II cases, we need the upper teeth to move back and the lower teeth to move forward (FIG. 23). The patient wears the lower aligner first.
5) The patient can push the socket part of the corrector that is marked on the outside of the socket (R: Right, and L: Left) into the buttons on the right and left molar regions of the upper aligner while the aligners are out of the mouth. The patient now:
b) Wears the upper aligner with the snap-on connectors (i.e., the socket connectors) already attached to the buttons. The patient grabs the push rod and pushes on the telescopic spring upward and snaps the socket connector onto the ball on the lower aligner and now the device is active (FIG. 22). It is either on both sides, or might be needed only on one side (i.e., dental midline corrections, unilateral bite corrections, or facial asymmetries). We have already made this pre-measured telescopic mechanism slightly longer by turning the push rod counterclockwise (or clockwise to lessen the forces as needed) so the spring can be activated or compressed gently after the snapping insertion. We normally need about 6 oz of force which is built into the spring already and can be measured at any time by a gauge. The total time required to connect the device should not require more than 30 seconds initially, and 10-15 seconds once the patient is experienced with installation. Aligners for skeletal cases are also contemplated by wrapping the distal part of the aligner around the posterior teeth to help create a grouping of teeth for jaw movements, or just dental movements by releasing the last teeth in the aligners, to allow for more selective and easier teeth movements. In some embodiments, smaller elastic buttons are used in the lower first molar and upper cuspid areas as a safety measure so the patients can wear elastics in case there is a problem with the corrector or if the patient prefers to wear elastics during the day, and the treatment may stay constantly active. It must be noted that the placement of elastics and the corrector remain as opposite of each other. Ultimately, patients can stop either the elastics or the corrector if there are any issues without falling into any emergency situations.

In Class III cases as shown in FIG. 6, we need the upper teeth to move forward and the lower teeth to move back. The patient wears the upper aligner first.

The patient can push the molar socket connector part of the corrector that is marked on the outside of the socket (R: for the right and L: for the left) onto the buttons of the lower molar regions of the aligner while the aligners are out of the mouth. The patient now:

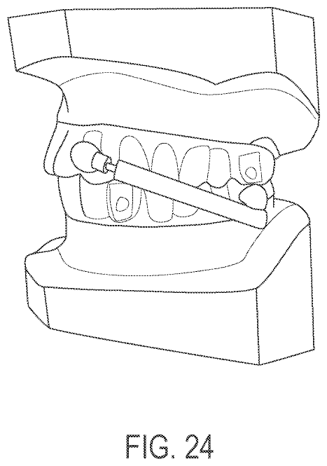

The patient connects the lower molar socket connectors of the snap on corrector to the buttons on both sides, or if needed to wear only on one side (i.e., dental midline corrections, unilateral bite corrections, or facial asymmetries as in FIG. 24) outside of the mouth. We have already made this pre-measured telescopic mechanism slightly longer by turning the push rod counterclockwise (or clockwise to lessen the forces as needed as in FIG. 21) so the spring can be activated or compressed gently after the snapping insertion. We normally need about 6 oz. of force which is built into the spring already and can be measured at any time by a gauge. We can build smaller elastic buttons in the upper first molar and lower cuspid areas as safety measures so the patient can wear elastics in case there is a problem with the corrector or if the patient prefers to wear elastics during the day, and the treatment may stay constantly active. It must be noted that the placement of elastics and the corrector remain as opposite of each other. Ultimately, patients can stop either the elastics or the corrector if there are any issues without falling into any emergency situations.

It must be noted that wearing the corrector at nights and the elastics during the day will potentially accelerate teeth movements. The reason is that the corrector in case of a Class II correction for example is pushing the upper molars back and the lower cuspids forward at night, while the elastics push the upper cuspids back and the lower molars forward during the day. In case of Class III situations, the corrector is pushing the lower molars back and the upper cuspids forward at night while the elastics push the lower cuspids back and the upper molars forward during the day. This can create an effective synergistic effect!

It is imperative to note that one or more embodiments of this telescopic mechanism of the corrector has at least three major advantages over many of the other or similar features. The first one is that this corrector is easily removable and not fixed, therefore patients can manage emergencies without seeing the orthodontist until the situation is resolved. The second and another important feature is that all teeth movements are under control, while the corrections are taking place. In other words, not only the correction of the molars and cuspids but all the rest of the teeth into ideal positions are taking place concurrently into a perfect occlusion. This cuts down on treatment time much more than some other techniques. The third advantage and another important factor is that if the patient does not wear the elastics to make the corrector active, and there will NOT be any negative side effects as we have with some of the featured devices in the market requiring elastics wear to negate the unwanted forces of the devices. Some of the telescopic mechanisms in the market rely solely on the patient's cooperation to fight the negative side effects. Because those appliances are fixed and bonded to the teeth, they can worsen the issue if the patient is not wearing the elastics, and may cause true orthodontic emergencies if part of their device accidentally detaches from the teeth, and unfortunately the patient may not be able to remove the device.
6) This design can even be configured with braces. Ball hooks could be pre-made on the surfaces of the upper molar bands (FIG. 7) and the lower cuspids brackets (FIG. 8) about the same size as the buttons on the elastics. There must be a special design as stated and shown in FIGS. 7 and 8. The slot on the band is for the wire to be slid within (FIG. 9), and also on the cuspid through the ball hooks to allow for the wire to be inserted (FIG. 10). This same design could be fabricated for both Stainless steel or Ceramic braces as well as bondable stainless or ceramic molar brackets. Therefore, the patient can wear this extremely versatile and effective corrector instead of the rubber bands for all Class II and III corrections. These ball hooks can be used for placement of rubber bands, too. We recommend keeping them on at all times if needed or to wear it at bed-time for less complicated corrections. We can measure and install this in less than a minute, and patients can remove it at any time in less than 5 seconds.

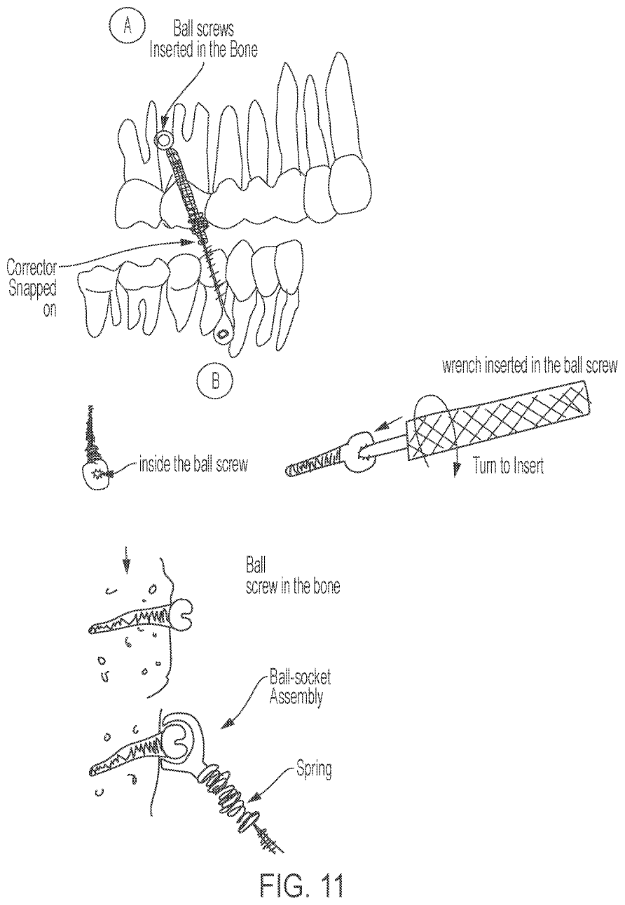

As seen in FIGS. 9 and 10, the socket connectors are press fit by hand on the ball (ball hooks) to connect the corrector to the teeth.
7) This Corrector may be used in case of pure skeletal advancements or retractions in growing children by inserting Ball screws in the upper and lower jaw bones above the upper first molars and lower cuspids. The concept of these Ball screws is similar to Temporary Anchorage Devices (TADS) currently in use for orthodontics. We need to make the Ball screws slightly larger ~2.5-2.8 mm in size and create a 1 mm Torx style screw receptacle inside the balls (FIG. 11) so an L-shaped key wrench can be inserted into the screw. The Ball anchors into the bone under local anesthesia or topical anesthetics (FIG. 11). These correctors may be used in conjunction with braces, aligners or just by themselves. In Skeletal cases, it is best to keep the corrector on at all times or 14 hours for the minimum, but again they can be removed as necessary.

In at least some embodiments, the telescopic mechanism allows the patient to open the mouth without any restrictions for both Class II and III corrections, where the forces are always directed by pushing rather than pulling. In the spring and push/pull rod mechanism described herein, there will be resistance upon opening the mouth. This is a disadvantage in case of the aligners as they may be pulled away from the upper and lower teeth so they can easily pop out, but not with braces other than just the restriction. Another advantage of one or more embodiments of this mechanism is again due to its pushing mechanism upon closure, therefore the aligners will seat and stay in the mouth securely compared to the use of elastics (rubber bands). With respect to the elastics, the forces are always directed by a pulling mechanism where the aligners have a tendency to either pop out or move up and down at times when the patient opens the mouth, therefore it could be frustrating for the patient and the operator, but we do not have this issue with the telescopic mechanism. The area of the aligners where the slits or cuts are made for the elastic connections may flare out with the elastics and cause irritations to the patient's cheeks and lips, as well. The compression spring/telescopic push rod mechanism of one or more embodiments of the corrector will be possibly the best and most effective way to use for both the aligners, braces, sleep apnea devices or the bone screw attachments in case of both Class II and III malocclusions or skeletal discrepancies in growing children.

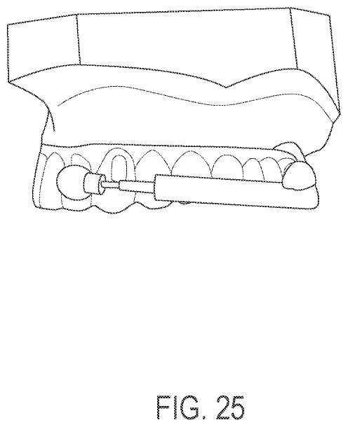

The device is extremely versatile and is also usable for other corrections such as within the same arch. Molars that need to be uprighted in cases where the teeth are tilted too far forward (mesially), which is called distalization of the molars, are able to be pushed back (FIG. 25). In this case, the spring is a compression spring to create the pushing action upon connections. It is best to place the buttons directly on the teeth to be distalized rather than the aligners and to cut (or otherwise form openings in) the aligner around the buttons so that the corrector can be connected. Bio-mechanically, it is best to keep the buttons on the aligners where all teeth can be used as a group anchor against the tooth being distalized. In case of full braces, it should not matter and the routine orthodontic biomechanics can be applied. We can utilize the exact mechanism that was described above with a spring and push/pull rod mechanism which is fully adjustable. This is the description for FIG. 25 in which the snap-on connections are within the same arch. Again, this device is removable and teeth movements are controlled whether with braces or aligners.

If the corrector is made in such a way that the spring becomes activated in response to being snapped to the buttons (to create a pulling tension instead), the corrector is usable to help with space closures within the same arch (whether upper or lower posterior teeth). It will help bring the teeth together by a pulling mechanism rather than a pushing action. Again, it is best to place the buttons directly on the teeth to be mesialized rather than the aligners and to cut (or otherwise form openings in) the aligner around the buttons precisely so that the corrector can be connected. Bio-mechanically, it is best to keep the buttons on the aligners where all teeth can be used as a group anchor against the tooth being mesialized. In case of full braces, it should not matter and the routine orthodontic biomechanics can be applied. We can utilize the exact mechanism that was described above with a spring and push/pull rod mechanism which is fully adjustable. This is the description for FIG. 25 but consider a pulling action instead; in which the snap-on connections are again within the same arch and teeth are fully controlled with aligners or the braces.

In at least one embodiment, the Corrector is positioned to be connected across the palate on the molars to push out on the molars and help with expansion of the arch as well as posterior crossbite corrections where the upper molars must be moved toward the cheeks. In at least one embodiment, this corrector also could be used with full coverage upper and lower occlusal acrylic splints (similar to night-guards) to help push the lower jaw forward in adults at nighttime. The corrector is extremely effective in opening the posterior pharyngeal space (airway) to help patients with sleep apnea.

This spring and telescopic rod mechanism also can be used directly on upper and lower posterior teeth or bone screw, when there is what is called a super-eruption of a tooth (also referred to as extrusions). Super-eruption of teeth occurs when the opposing teeth are missing (extractions, congenitally missing teeth, broken down teeth, or the like) and therefore the tooth over-erupts into the opposing missing-tooth space. This is extremely challenging in orthodontics to push the super-erupted tooth back into the bone socket (intrusion) so that the lost opposing clinical space can be recovered. With the ease of placement of dental implants these days, a lot of adult patients seek to recover these spaces whether the teeth are drifted or the opposing teeth are super-erupted, so that they can have clinical crowns placed on these implants for better function and aesthetics. This snap-on corrector therefore can be a great tool while connected to a button placed on the tooth that is cleared and being controlled by the aligners on one end and on the bone screw button on the other end. The bone screws potentially can be placed both on the buccal (toward the cheek side) and or on the lingual/palatal (toward the tongue) in the jaws, and on the same spots on the tooth being intruded. The placement of bone screw buttons and the tooth buttons are all dependent on what needs to be achieved, as the placement of the corrector on either side has a tendency to push that side in more than the other, therefore for pure intrusions of teeth, placement of the corrector on both buccal and the lingual will be ideal especially in the case of aligners where torquing is more challenging than with the braces. We can ask the patient to keep the corrector/s on at all times with braces, and to only remove the aligners when the patient is eating. In case the patient likes to remove the corrector for brushing before bed-time, cleanings, emergencies or even to wear only during the day, they can do that with ease. This will be extremely effective and achieve the corrections within 2-3 months maximum. The intrusion of molars in open-bite cases where the front teeth do not touch are considered a very nice orthodontic technique to help with the bite closures. This corrector again can be used the same way on the posterior teeth (molars) to help with intrusions and thus closing the bite very effectively. I call this intrusion technique a nutcracker effect, where the bigger size walnut is replaced with a hazelnut to help the nutcracker handles come closer to each other.

A terrific advantage of one or more embodiments of this system is that in the snap on version of this telescopic corrector for both Class II and III corrections, the same side assembly can be used. So, the left telescopic and the right telescopic assemblies can be used for both Class II or III corrections of the same side. In other words, the molar snap on could be connected to either the upper molar or the lower molars and the same pertains to the cuspids, depending on what classification of occlusion needs to be corrected (only the direction of the forces will be changed). Therefore, fabrication at the factory and the inventory for the doctor stays simple, limited and effective.

FIG. 19 is an image of another version of the spring telescopic rod which is all in white acrylic. It is more aesthetically pleasing especially in cases of aligners or the ceramic braces, and the compression spring is housed within the thickest diameter area of the cylinder. As the patient closes their mouth and the telescopic cylinders slide within each another, the spring becomes compressively active and the movement of the teeth starts. In at least some embodiments, the correctors are in different colors/patterns to make them more fun for the younger and teen patients. The black snap on heads (socket connectors) also can be made in white to make it very incognito in use.

In at least one embodiment, at the end of the first cylinder of the telescopic corrector where the spring is situated within, there will be a removable cap. Therefore, the spring can be removed for selections of different sizes if needed, or to allow fabrication of a compression versus a tension spring.

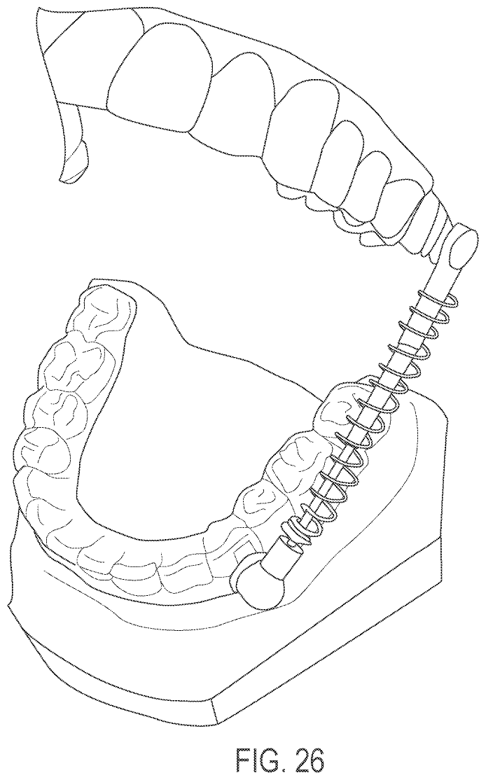

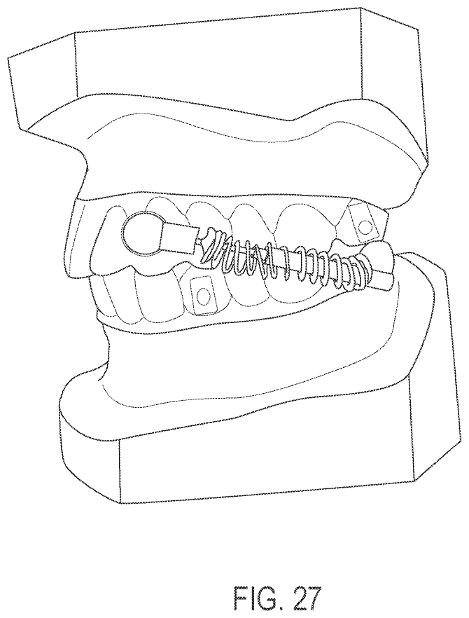

FIGS. 26 and 27 are images of another version of the corrector. The spring is on the outside of the telescopic rod. It might be easier to make a stronger spring in this version; however, it is not as aesthetically pleasing for the patients.

A corrector assembly according to another embodiment usable with the snap on corrector described above utilizes the following or a similar mechanism of action described above for the snap-on correction. According to an embodiment, a different locking module for the braces is described as follows.

The first and second socket connectors are connected to the ends of the telescopic spring device. In at least one embodiment, the device is for the correction of Class III skeletal and dental issues (lower jaw and/or teeth sitting more forward compared to the upper jaw and/or teeth). In at least one embodiment, the device is usable with braces and/or combined with other fixed appliances connected to the upper and/or lower jaws/arches in early treatment of growing children.

The first socket connector is as described above. The first socket connector is for connecting the large cylinder of the telescoping part of the device to an orthodontic mount (also referred to as a band) on the upper molar of a patient. In some embodiments, the first socket connector is used to connect the telescopic spring.

The second socket connector is as described above and is connected at the end of the push rod of the telescopic spring. The second socket connector is for connecting the push rod onto a ball on a mount (also referred to as brackets) on the lower bicuspid or the first bicuspid and the cuspid of a patient for Class II patients. In some embodiments, the second socket connector is hingedly or rotationally crimped at the end of the push rod such as the Forsus which is hard to remove even with pliers. The socket connector enables quick and easy release of the second socket connector (at the end of the push rod) from the ball on the mount. The second socket connector can then be repositioned on balls of two different mounts on the upper teeth of the patient for class III cases. In at least some embodiments, at least a portion of the push rod near the second socket connector is angled to minimize the rod from flipping out into the patient's cheek. In at least some embodiments, depending on the application and size span, the compression spring may have different sizes and can be changed through the end cap of the large cylinder. In other embodiments, the tension spring has a larger or smaller amount of elastic force to assist with pushing forces.

There are two parts to the device. In at least some embodiments, the socket connectors are already soldered or connected to the pieces prior to use, e.g., in the factory. The first socket connector which is connected to the upper molar tube, is pre-connected onto the telescopic spring part (with a ball joint) to allow for ease of movement during mastication. The other part is the push rod of the telescope which is threaded at the end that gets screwed into the tension spring and includes the second socket connector that gets connected to the bicuspid/cupid area. Therefore, the telescopic spring gets connected to the upper molar band by snapping the first socket connector to the ball on the molar band. There will be a ball joint on the telescopic part and the first socket connector to allow ease of movement. The second socket connector will be grabbed and pushed back to install on a ball on the bicuspid/bicuspid or bicuspid/cuspid brackets. In at least one embodiment, this connection takes no more than 30 seconds. For future activations, the socket connector gets disconnected from the ball in seconds, and the push rod is held with a plier and the socket connector/pull rod will be threaded counterclockwise (will be a ~5-6 mm pitch) to make the device longer to create more activation upon closure, and reconnect the socket connector. So, installations, adjustments and removals can be performed all in seconds after proficiency.

We need to be able adjust the corrector during installation as well as during the process of the correction of the teeth. Once the patient closes maximally; the rod slides into the middle cylinder to eventually push the middle cylinder onto the spring within the large cylinder (FIG. 16). The rod can freely slide in the middle cylinder as well as within the spring in the large cylinder. The rod has to be a bit longer than the middle cylinder to allow the telescopic feature to have the capability to become as long as possible for maximal opening of the mouth without restrictions.

Having telescopic springs in 5 sizes of 18, 23, 25, 27, 32 mm gives the operator flexibility. In some embodiments, longer or shorter spring lengths are usable. In at least one embodiment, a total telescopic spring size of about 25 mm in average length with the threaded portion of about 6-8 mm again will be sufficient to create less forces by threading in or to push more (threaded out to make longer) and activate. In a Forsus-style arrangement embodiment, the spring size is always the same as about 23 mm, and we have different size rods to be able to activate initially. An issue that arises in other approaches is if the patient opens the mouth wide, the rod and the spring sometimes may separate due to its design and can potentially hurt the patient. In at least one embodiment of the present invention, the spring can never be separated no matter how wide the patient opens, because the telescopic spring is all sliding within each other and can not separate.

A goal of the additional threading is to impart a range of tension from about 6 ounces to about 8 ounces of force for varying lengths. In at least one embodiment, each complete rotation of the threaded rod into the spring adjusts the tension force by 2 ounces of forces due to lengthening the span of the device.

Thus, the doctor is able to vary the amount of force being applied to the movement of the teeth by greater or lesser threading of the threaded rod into the spring. Additionally, repositioning of the attachment is simplified using the second socket connector. Current approaches using a Forsus appliance require the crimping of wire ends in the mouth of the patient which is uncomfortable and very hard to remove with a possibility of accidental pinching of the lips.

### Attachment Placement for Orthodontic Aligner Treatments

One or more of the following issues exist with other approaches.
1) Because we don't know the exact placement of these attachments, the entire surface of the tooth gets etched with 37% phosphoric acid, which is not necessary.
2) After the primer is applied and aired, the primer gets all over the teeth and at times in the embrasures and contact areas forming a thin coat all over; which again is not necessary.
3) After placement of the template with the composite bonding material over the teeth, the excess material seeps around the attachments, therefore after a curing process, this unwanted extra material gets bonded to the teeth around the attachments. Because we have etched and primed pretty much the entire tooth surface, the excess material bonds very strongly to the teeth. If the template is underfilled to prevent the excess, there is a chance of having a void inside the attachments or they may not even stay on the teeth. Knowing the right amount of material needed is almost impossible to predict. If the attachments are left with these major or minor voids, they easily become stained later, and become unsightly and the patients are not happy.
4) The orthodontist has to spend a good amount of chair-time to go around the attachments to clean the extra material. It is hard to accurately see the materials at times or to reach behind the attachments toward the back, or near the gingival areas. As we go around these attachments to clean with our highspeed (drills), we may accidentally cut or nick the attachments or the enamel. Keeping perfect and clean shape attachments remains crucial to the success and effectiveness of the treatment-something pretty hard to achieve with this process. At times, the teeth accidentally get bonded together should the primer, or the composite material seep into the contact areas which happens pretty often especially with inexperienced assistants. It is painstaking and pretty hard to clean those areas, time consuming to open up the bonded contact areas. All teeth with attachments must be flossed to make sure that we have not bonded them together after the attachment placements.

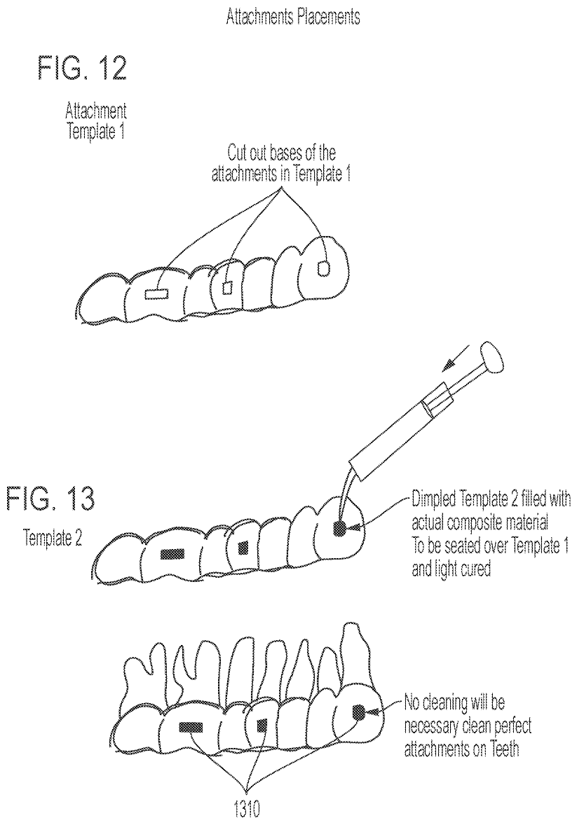

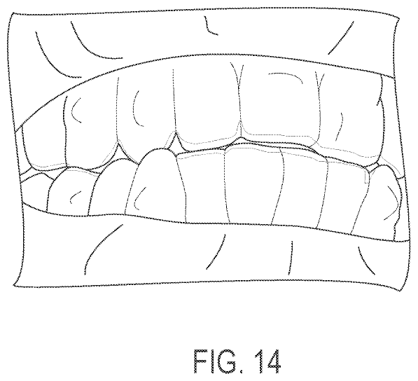

In accordance with one or more embodiments, the following method is disclosed.
1) Two attachment templates as shown in FIGS. 12 and 13 are used. These templates seat over each other. In effect, there is a two-layer template made into one.
2) Template 1, as shown in FIG. 12, is a very thin (the thinnest template possible: ~0.5 mm or less in some embodiments) maybe even a bit thinner than what is currently in use. This template has the exact shape of the base area of the attachment that gets bonded to the teeth in them. So, when the template is seated on the teeth only the areas of the teeth for bonding of the attachments is visible through the orifices, and everywhere else is covered with the Template 1 (FIG. 12).
3) The exterior part of Template 1 around the orifices must be dabbed with a very thin coat of Vaseline or preferably Tinfoil substance used in dentistry (such as COE-SEP) before seating on the teeth or this could be done at the lab before shipment. Template 1 is seated over cleaned teeth, and the surfaces of those teeth areas to be bonded for the attachments are prepared. One-minute acid etching (via the gel format rather than liquid) is used, the gel is wiped with a Qtip or cotton roll or swab, and the enamel is rinsed with water. Therefore, the acid etch cannot get all over the teeth and only the areas needing to be bonded get etched. After drying the areas with the Template 1 seated, a thin coat of the primer is applied on the etched surfaces of the teeth, and this will get a bit on the Template 1 around the periphery of the attachment orifices after air blowing, and it will serve a great purpose. The primer is then cured, and this will seal the space between the Template 1 and the tooth. This prevents the composite materials from accidentally seeping on the teeth underneath the Template 1 around the attachments later.
4) Template 2, shown in FIG. 13, is now ready for the composite material to be injected into the bubble parts or negative areas of the template corresponding to the open areas or orifices of Template 1. The bubble parts (also referred to as dimples) of Template 2 protrude away from the tooth surface. The dimples are arranged to align with the open areas of Template 1 when Template 2 is positioned over Template 1. So, after the materials are injected into the dimples, Template 2 is seated (positioned) over Template 1. The curing light is used to cure all the composite materials. The positioning attachments 1310 are now bonded on the teeth.
5) Template 2 now will be removed easily and also any materials that are sandwiched between the two are solely inside the Template 2, or on the exterior of Template 1. The templates will not bond to each other because we have already used the Tinfoil substance or Vaseline on the exterior of the Template 1.
6) We then proceed to remove Template 1. If there are any materials around the positioning attachments 1310 they are on the Template 1, and not the teeth. They flake off easily because of the Tinfoil or Vaseline material. The assistants can also go around the attachments 1310 with an explorer (hand instrument) to clean and flake off the materials, if needed. In an embodiment, very fine (almost non-visible) vertical slits are formed on the Template 1. Each slit is from the bottom of the attachment (for lower teeth) or top of the attachment (upper teeth) toward the gingival margin of the template. This way there is more play and flexibility and an easier way to lift the template away from the teeth without any difficulties. These vertical slits will get sealed with the primer too so the composite material cannot seep in. If by any chance the doctor needs to remove much excess materials around any of the attachments with the high-speed drill due to excessive material, it will be still easy because we are removing materials from Template 1 and not the teeth; however, the chances remain extremely low for any damage to the teeth. Even if we get a very thin amount of composite seeping on teeth; which is almost impossible because the primer that already sealed around the orifices in Template 1, the composite cannot bond to the enamel easily, because we have purposely not prepared the periphery of the attachment 1310. The teeth have beautiful, clean and untouched attachments on them without any flash nor any of the other issues already stated. Next, the aligner is positioned on the teeth as shown on FIG. 14 and the treatment is started.
7) As you see the idea is effective, clean, inexpensive and requires pretty much zero doctor's time. There is no stained flash later, and the shapes of the attachments 1310 are perfectly sculpted. The aligners that are fabricated and have the attachments 1310 incorporated in them must digitally compensate and add to the depth of the attachments 1310 for the extra tiny thickness of the Template 1 (should not be more than ~0.5-0.75 mm).

Considering how Template 1 can stay engaged quite nicely on the attachments due to the created orifices, some of the “actual” aligners during the process potentially could be made in this design for some difficult tooth movements toward the end in the finishing or refinement process. These could be mainly the extrusions (over-erupting) upper and lower anterior teeth, including possible rotations of the posterior teeth by attachment placements in both buccal and lingual areas of teeth to help with coupling and even for elastic connections by the patients at bedtime over the aligners. The inventor believes that the aligners can grab the positioning attachments 1310 much more effectively this way for difficult or sometimes near impossible movements. The orifice sizes must be modified regarding each particular movement accordingly, so the teeth can move and have sufficient adjustment, i.e., play or wiggle, room. It must be noted that if the positioning attachments 1310 do not fit well into the aligners, with patients moving into the subsequent aligners, they will gradually not only not help with alignment but prevent the aligners to even seat correctly, and can move the teeth in unwanted or worse positions.

### Digitally Assisted Direct Bracket Bonding System

In orthodontics, precise bracket positioning is very challenging. A lot of different approaches have been tried and some are currently being used to help with this problem. While I have proposed a bonding technique to be able to reposition the brackets later by slide and fly mechanism without the actual removal of the bracket, all efforts must be made to place the brackets as accurately as possible from the start. However, it is impossible to avoid bracket repositioning one hundred percent of the time no matter how hard we try because we are dealing with nature, operational errors and at times due to severe positioning of the teeth.

These days in orthodontics, indirect bonding has become popular and getting more attention. In this case, the brackets are placed on models with wax ahead of time, and clear flexible trays (also referred to as jigs) will be made over the brackets and the model. Therefore, once the jigs are removed the brackets will come off along with it inside the tray. This jig that carries the brackets (which have been coated with bonding materials), will be seated over the already prepared surfaces of the teeth and cured with a light. Once the jigs are removed the brackets will stay bonded on the teeth and therefore the braces are placed based on what has been done at the lab or possibly the orthodontist in his office. There are a couple of issues with this system, and the main issue is that we allow the technicians to place the brackets on the teeth and it may not be to the orthodontist's desire necessarily. The second factor which must be seriously considered is the cost. In today's era with all other rising supply and equipment costs and low profitability, it may not be cost effective for the orthodontist to pay top dollar for these jigs. At the end of the day, some of these brackets may come off due to patient's breakages while eating hard foods so they must be bonded directly later anyway, or may not stay on the teeth in the first place as the bonding materials can rub off during the process of seating the jigs. They may have to be repositioned later because of their poor positioning by removing the bracket, cleaning and repeating the entire procedure and placing it and potentially with a new bracket in case the old one is distorted. Therefore, it really may not justify the extra lab cost for these jigs that are expensive, too.

In accordance with a method according to an embodiment, we scan the bracket bases of all popular brackets in the market. The brackets all have particular shapes and are manufactured by many different companies. After obtaining the exact sizes and shapes of the brackets including the bases scanned, the data representing the size and shape of the brackets will be stored in a database. The orthodontist scans the patient's teeth by using a scanner (e.g., iTero) and stores the scan data. After the scans of the teeth are complete, the exact bracket used by the orthodontist, such as 3M, Ormco, American, etc., for their patients is selected. Once the bracket type is selected, the digital brackets are displayed on the screen as how the orthodontist normally sets them on the bracket trays, showing all the upper and lower brackets. Therefore, the orthodontist will select the desired bracket (which is for that particular tooth) with a cursor and by holding the left button of the mouse he/she will be able to drag and move it and place it on the three dimensional scan of each tooth (STL). The orthodontist will be able to move the bracket in any direction (360 degrees) as well as up and down to place it as best as possible on the tooth like in the patient's mouth. This will be repeated for all the desired teeth to be bracketed. The software will have a measurement grid so the orthodontist knows exactly where the brackets are being placed and is able to measure the cusp tips and along the sides of the teeth to the bracket, or the like. The software can also incorporate any 3D radiographs to see the root structures, and display in the upper left corner, while the bracket placements and positioning are being done to assist with as accurate bracket placements, as possible. Once the operator is satisfied with the placement of the brackets on the teeth, he can also run a diagnostic by placing a virtual wire in the brackets and allow the virtual correction of the teeth. This will help the orthodontist to see how the teeth will be leveled and straightened initially and what to expect over time. Therefore, repositioning can be made right there and then until all the leveling looks acceptable to the orthodontist. After completion, the software stores the scan of the teeth, bracket selection, and bracket positioning.

After the teeth scan with the brackets on them is stored, the brackets will be removed virtually, but the exact placement of that particular bracket base will be shown on the teeth. Therefore, a template with all the precise duplicate cut outs of the bases of the brackets in it is printed. The bracket templates are similar to Template 1 (FIG. 12) of the attachment templates system described above. The bracket templates are roughly about 0.5 mm in thickness or as needed based on the thickness of the bracket base. The bracket templates have very fine vertical cuts from the gum line to the bracket orifices for ease of removal later.

In at least one embodiment, the stored scan of the teeth, bracket selection, and bracket positioning information is transmitted to another computer for processing and printing of the bracket template. The bracket template is then sent to the orthodontist.

After the templates are ready to be used, the assistants prepare the teeth to be bracketed. After the teeth are etched and primed, the template is seated on the teeth, or we can seat the template and then prepare the teeth depending on the preference of the orthodontist. At this point, each tooth has an orifice showing where the brackets are going to fit. All the assistants have to do is to carry the brackets with their bases that are already coated with the bonding material, and place them in the cut out orifices which is an exact match of the bracket base. After the brackets are all seated and fitted perfectly in them, a curing light is shined, and the brackets are now bonded to the teeth. The templates are removed and the patient's braces are on.

A major advantage of at least one embodiment of this system is that:
1) The orthodontist has placed the brackets indirectly on the teeth where he would prefer, without additional time spent manually placing the brackets on the patient's teeth, losing time or doing guess-work in the patient's mouth. Yet, the brackets are placed directly on teeth by the assistants rather than sitting a jig with all the bonding materials that can rub off the bracket bases when they are being seated indirectly. Therefore, the chances of bracket failure will be much less.
2) We can seat the template before etching and priming as mentioned. This will eliminate unnecessary etching and priming of the bracket periphery. The teeth can stay dry and the chances of contamination by saliva will be drastically reduced due to isolation of the teeth.
3) The fabrication of these templates can be priced very reasonably and competitively in the market, so all orthodontists can save a lot of money and benefit from it.
4) If this is combined with the bonding technique for repositioning the brackets later as necessary, one can expect nothing but impeccable results with so much ease and time efficiency.

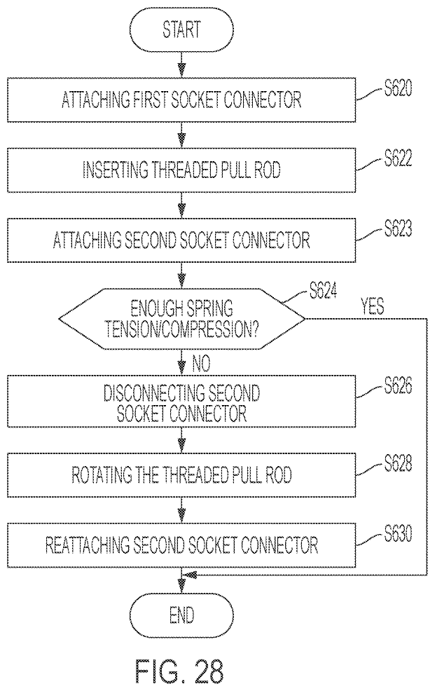

FIG. 28 is an operational flow for using an orthodontic device for orthodontic treatment, according to at least one embodiment of the present invention. The operational flow provides a method for orthodontic treatment. In at least some embodiments, the method is performed by using an orthodontic device, such as orthodontic device 200 shown in FIG. 2.

At S620, the first socket connector is attached. In at least some embodiments, the first socket connector is attached to an upper tooth band of a patient. In at least some embodiments, the first socket connector may be first socket connector 202 shown in FIG. 2(a) and 2(b).

At S622, the threaded pull rod is inserted. In at least one embodiment, the threaded pull rod is inserted into the elongated spring to a first distance or depth. In at least one embodiment, the first distance or depth is 2 mm. In at least some embodiments, the pull rod may be pull rod 208 shown in FIG. 2(a) and 2(b).

In at least some embodiments, S622 occurs prior to S620.

At S623, the second socket connector is attached. In at least some embodiments, the second socket connector is attached to a ball on a mounts (brackets) on the lower teeth of the patient. In at least some embodiments, the second socket connector may be second socket connector 210 shown in FIG. 2(a) and 2(b).

At S624, whether there is enough spring tension/compression is determined. In at least some embodiments, whether the spring has enough tension/compression is determined after the second socket connector is attached. When the spring is not under tension and the threaded rod is attached, the length of the variable tension pull rod is less than the distance from the upper molar attachment point to the closer of the two lower brackets on the teeth. In at least some embodiments, the threaded pull rod is turned to be threaded into the spring while leaving an additional 4 mm of threading available on the threaded pull rod. In this manner, when attaching the second socket connector to the ball on the lower teeth mount, the spring is put under tension and stays active (under tension) at all times. Thus, when the patient opens his/her mouth, the tension in the pull rod results in an even more but yet gentle pulling motion (back into the patient's mouth) on the lower teeth and a pushing motion (out of the patient's mouth) on the upper teeth. In at least some embodiments, the spring is put under compression instead of tension. In at least some embodiments, the additional threading is about 6 mm instead of 4 mm, and a goal of the additional threading is to impart a range of tension from about 6 ounces to about 8 ounces of force. In at least some embodiments, the initial length of the threaded pull rod extending outside the elongated spring is at least 6 mm. In at least some embodiments, each complete rotation of the threaded rod into the spring adjusts the tension force by 2 ounces of forces due to shortening the span of the device. In at least some embodiments, the tension of the variable tension pull rod ranges from 0 to 8 ounces of force. In response to the spring having not enough tension, the operational flow proceeds to disconnection of the second socket connector at S626. In response to the spring having enough tension, the operational flow ends.

At S626, the second socket connector is disconnected. In at least some embodiments, the second socket connector is disconnected from the ball on the lower teeth mount.

At S629, the threaded pull rod is rotated. In at least some embodiments, the threaded pull rod is rotated to extend further into the elongated spring. In at least some embodiments, the threaded rod is rotated by making a single turn of the threaded rod within the elongated spring. In at least some embodiments, each single turn results in a 1 mm reduction in the length of the orthodontic device. In at least some embodiments, each single turn results in an increase in force of 1 ounce.

At S630, the second socket connector is reattached. In at least some embodiments, the second socket connector is reattached to the ball on the lower teeth mount.

As the teeth shift, the spring is under less tension. In at least some embodiments, after sufficient movement of teeth, the second socket connector is disconnected from the ball of the lower teeth mount by unsnapping the socket connector from the ball, and the threaded pull rod is turned in clockwise to be threaded further into the spring. In at least some embodiments, the threading in the pull rod and spring is such that the threaded pull rod is turned counter-clockwise to be threaded further into the spring. The overall length of the variable tension pull rod is thereby reduced. In at least some embodiments, each complete turn of the threaded pull rod imparts an additional 1 ounce of force. In at least some embodiments, the threaded pull rod is turned each time to reduce the overall length by 1 mm. In at least some embodiments, each turn of the threaded pull rod reduces the overall length by more or less than 1 mm. In at least some embodiments, the second socket connector is then reattached to the ball on the lower teeth mount by snapping the socket connector onto the ball thereby putting the spring into tension and continuing to pull on the lower teeth and push on the upper teeth. In at least some embodiments, the process is then repeated when there is not enough tension on the spring.

In at least some embodiments, the doctor is able to vary the amount of force being applied to the movement of the teeth by greater or lesser threading of the threaded pull rod into the spring. In at least some embodiments, the amount of force is varied by rotating the threaded pull rod within the elongated spring. Current approaches using a Forsus™ appliance require the crimping of wire ends in the mouth of the patient, which is uncomfortable and time consuming, and with the possibility of harm to the patient. In at least some embodiments according to the present invention, repositioning of the attachment is simplified using the socket connector.

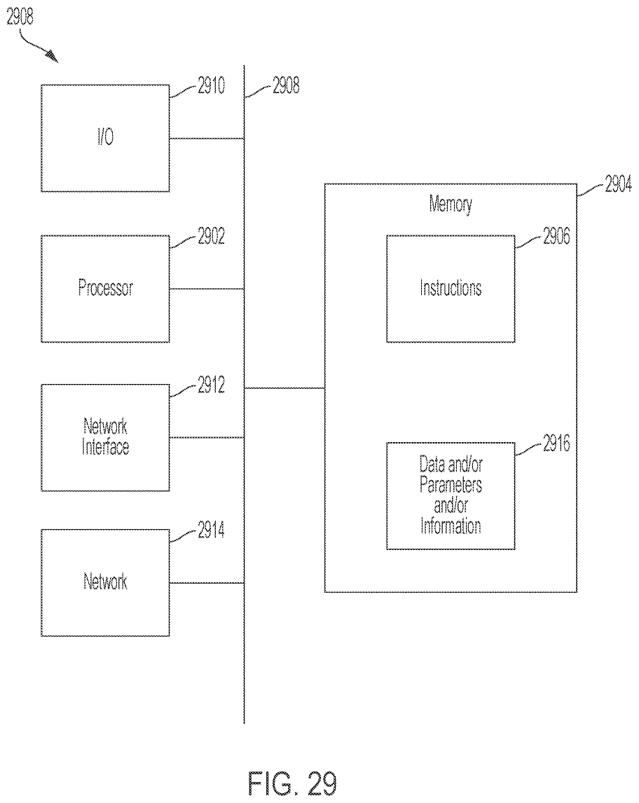

FIG. 29 is a block diagram of a processing system 900 in accordance with some embodiments.

In some embodiments, processing system 2900 is a general purpose computing device including a hardware processor 2902 and a non-transitory, computer-readable storage medium 2904. Storage medium 2904, amongst other things, is encoded with, i.e., stores, computer program code 2906, i.e., a set of executable instructions. Execution of instructions 2906 by hardware processor 2902 represents (at least in part) a tool which implements a portion or all of the methods described herein in accordance with one or more embodiments (hereinafter, the noted processes and/or methods).

Processor 2902 is electrically coupled to computer-readable storage medium 2904 via a bus 2908. Processor 2902 is also electrically coupled to an I/O interface 2910 by bus 2908. A network interface 2912 is also electrically connected to processor 2902 via bus 2908. Network interface 2912 is connected to a network 2914, so that processor 2902 and computer-readable storage medium 2904 are capable of connecting to external elements via network 2914. Processor 2902 is configured to execute computer program code 2906 encoded in computer-readable storage medium 2904 in order to cause system 2900 to be usable for performing a portion or all of the noted processes and/or methods. In one or more embodiments, processor 2902 is a central processing unit (CPU), a multi-processor, a distributed processing system, an application specific integrated circuit (ASIC), and/or a suitable processing unit.

In one or more embodiments, computer-readable storage medium 2904 is an electronic, magnetic, optical, electromagnetic, infrared, and/or a semiconductor system (or apparatus or device). For example, computer-readable storage medium 2904 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 2904 includes a compact disk-read only memory (CD-ROM), a compact disk-read/write (CD-R/W), and/or a digital video disc (DVD).

In one or more embodiments, storage medium 2904 stores computer program code 2906 configured to cause system 2900 (where such execution represents (at least in part) the EDA tool) to be usable for performing a portion or all of the noted processes and/or methods. In one or more embodiments, storage medium 2904 also stores information including data and/or parameters and/or information 2916 which facilitates performing a portion or all of the noted processes and/or methods.

Processing system 2900 includes I/O interface 2910. I/O interface 2910 is coupled to external circuitry. In one or more embodiments, I/O interface 2910 includes a keyboard, keypad, mouse, trackball, trackpad, touchscreen, and/or cursor direction keys for communicating information and commands to processor 2902.

Processing system 2900 also includes network interface 2912 coupled to processor 2902. Network interface 2912 allows system 2900 to communicate with network 2914, to which one or more other computer systems are connected. Network interface 2912 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more systems 2900.

System 2900 is configured to receive information through I/O interface 2910. The information received through I/O interface 2910 includes one or more of instructions, data, design rules, libraries of standard cells, and/or other parameters for processing by processor 2902. The information is transferred to processor 2902 via bus 2908. System 2900 is configured to receive information related to a UI through I/O interface 2910. The information is stored in computer-readable medium 2904 as user interface (UI) 2942.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, a portion or all of the noted processes and/or methods is implemented as a software application that is used by system 2900.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A snap on corrector for orthodontic treatment, the corrector comprising:
a variable tension pull rod having a two-piece construction including:
an elongated spring having a threaded portion at one end; and
a threaded rod with a correspondingly threaded portion to fit into the threaded portion of the elongated spring;
a first socket connector connected to an end of the elongated spring; and
a second socket connector connected to an end of the threaded rod, the second socket connector at an end distal from the first socket connector during insertion of the threaded rod in the elongated spring.

2. The snap on corrector as claimed in claim 1, further comprising:
a first button/ball configured to fit within the first socket connector; and
a second button/ball configured to fit within the second socket connector.

3. The snap on corrector as claimed in claim 2, wherein the first button/ball is mounted on at least one of bracket, tooth, or aligner.

4. The snap on corrector as claimed in claim 3, wherein the bracket is configured to be mounted on a tooth of a patient.

5. The snap on corrector as claimed in claim 2, wherein the second button/ball is mounted on at least one of a bracket, tooth, or aligner.

6. The snap on corrector as claimed in claim 5, wherein the bracket is configured to be mounted on a tooth of a patient.

7. The snap on corrector as claimed in claim 1, wherein the corrector is attached to at least one of:
a ball hook on a molar or cuspid bracket; or
a ball screw mounted in a bone structure of a patient.

8. A method of using a device for orthodontic treatment, the device having a variable tension pull rod having a two-piece construction including an elongated spring with a threaded portion at one end and a threaded rod with a correspondingly threaded portion to fit into the spring threaded portion, comprising:
attaching a first end of the elongated spring to an upper tooth band, through the use of a first socket connector attaching to a first ball connected with the upper tooth band, of a patient;
inserting the threaded rod into the elongated spring to a first depth; and
attaching a first end of the spring threaded portion to a mount, through the use of a second socket connector attaching to a second ball connected with the mount, on lower teeth of the patient.

9. A snap-on corrector for orthodontic treatment with aligners or braces, the corrector comprising:
a main telescopic cylinder, having a spring therein, connected to a molar band via a first socket connector;
a middle cylinder capable of sliding into the main cylinder and creating compression forces of the spring;
a push rod capable of sliding in the middle cylinder and eventually into the main telescopic cylinder through the spring; and
a second socket connector being able to be threaded at an end of the push rod by a distance related to a pitch of a threading at an end of the push rod of the telescopic cylinder and the second socket connector being able to be connected to a cuspid region.

10. The snap-on corrector of claim 9, wherein the combined length of the second socket connector and the push rod is adjustable by rotation of the second socket connector on the threading of the push rod.

11. The snap-on corrector of claim 9, wherein the combined length of the second socket connector and the push rod is adjustable by rotation of the push rod with respect to the second socket connector.

12. The snap-on corrector of claim 9, wherein at least one of the first or second socket connector is configured to releasably receive a ball therein.

13. The snap-on corrector of claim 9, wherein at least one of the first or second socket connector is a Bansbach style connector.
